(19) United States
(12) Patent Application Publication
(10) Pub. No.: US 2016/0141572 A1
(43) Pub. Date: May 19, 2016

(54) LIQUID TRAP FOR A LITHIUM ION BATTERY SYSTEM

(71) Applicant: Johnson Controls Technology Company, Holland, MI (US)

(72) Inventor: Ken Nakayama, Franklin, WI (US)

(21) Appl. No.: 14/872,037

(22) Filed: Sep. 30, 2015

Related U.S. Application Data
(60) Provisional application No. 62/079,639, filed on Nov. 14, 2014.

(51) Int. Cl. H01M 2/12

(52) U.S. Cl. CPC H01M 2/1258; H01M 2220/20

(57) ABSTRACT

A lithium ion battery system includes a liquid trap system configured to collect liquid from a vent pathway associated with a lithium ion battery module. The vent pathway is configured to flow battery cell effluent away from the lithium ion battery module and out of the lithium ion battery system. The liquid trap system has a liquid removal path configured to fluidly couple to the vent pathway, a liquid collection vessel fluidly coupled to the liquid removal path and configured to collect liquid removed from the vent pathway, and a liquid outlet path of the liquid collection vessel configured to allow liquid to exit the liquid collection vessel. The liquid collection vessel has a position relative to the vent pathway that allows liquid within the vent pathway to move toward the liquid collection vessel by the force of gravity.

### CROSS-REFERENCE TO RELATED APPLICATIONS

This application claims priority to and the benefit of U.S. Provisional Application No. 62/079,639 entitled, “Battery Pack Vent Hose Design with Liquid Trap and Sensor,” filed on Nov. 14, 2014, which is incorporated by reference in its entirety for all purposes.

### BACKGROUND

The present disclosure relates generally to the field of batteries and battery modules. More specifically, the present disclosure relates to battery cell placement within lithium-ion (Li-ion) battery modules.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A vehicle that uses one or more battery systems for providing all or a portion of the motive power for the vehicle can be referred to as an xEV, where the term “xEV” is defined herein to include all of the following vehicles, or any variations or combinations thereof, that use electric power for all or a portion of their vehicular motive force. For example, xEVs include electric vehicles (EVs) that utilize electric power for all motive force. As will be appreciated by those skilled in the art, hybrid electric vehicles (HEVs), also considered xEVs, combine an internal combustion engine propulsion system and a battery-powered electric propulsion system, such as 48 Volt (V) or 130V systems. The term HEV may include any variation of a hybrid electric vehicle. For example, full hybrid systems (FHEVs) may provide motive and other electrical power to the vehicle using one or more electric motors, using only an internal combustion engine, or using both. In contrast, mild hybrid systems (MHEVs) disable the internal combustion engine when the vehicle is idling and utilize a battery system to continue powering the air conditioning unit, radio, or other electronics, as well as to restart the engine when propulsion is desired. The mild hybrid system may also apply some level of power assist, during acceleration for example, to supplement the internal combustion engine. Mild hybrids are typically 96V to 130V and recover braking energy through a belt or crank integrated starter generator. Further, a micro-hybrid electric vehicle (mHEV) also uses a “Stop-Start” system similar to the mild hybrids, but the micro-hybrid systems of a mHEV may or may not supply power assist to the internal combustion engine and operates at a voltage below 60V. For the purposes of the present discussion, it should be noted that mHEVs typically do not technically use electric power provided directly to the crankshaft or transmission for any portion of the motive force of the vehicle, but an mHEV may still be considered as an xEV since it does use electric power to supplement a vehicle's power needs when the vehicle is idling with internal combustion engine disabled and recovers braking energy through an integrated starter generator. In addition, a plug-in electric vehicle (PEV) is any vehicle that can be charged from an external source of electricity, such as wall sockets, and the energy stored in the rechargeable battery packs drives or contributes to drive the wheels. PEVs are a subcategory of EVs that include all-electric or battery electric vehicles (BEVs), plug-in hybrid electric vehicles (PHEVs), and electric vehicle conversions of hybrid electric vehicles and conventional internal combustion engine vehicles.

xEVs as described above may provide a number of advantages as compared to more traditional gas-powered vehicles using only internal combustion engines and traditional electrical systems, which are typically 12V systems powered by a lead acid battery. For example, xEVs may produce fewer undesirable emission products and may exhibit greater fuel efficiency as compared to traditional internal combustion vehicles and, in some cases, such xEVs may eliminate the use of gasoline entirely, as is the case of certain types of EVs or PEVs.

As technology continues to evolve, there is a need to provide improved power sources, particularly battery modules, for such vehicles and other implementations. One example of a battery module useful for the applications described above is one that includes multiple lithium ion electrochemical cells and other features for managing the operation of the cells under various conditions. Indeed, the ability of lithium ion electrochemical cells to be charged faster and in a more reproducible manner than other battery technologies (e.g., lead-acid electrochemical cells, nickel-cadmium electrochemical cells) makes them particularly suited to address various power requirements of the applications noted above, and others (e.g., household applications, boats, and the like). In this regard, many xEV and other applications include battery modules based on lithium ion technology, either alone or in combinations with other energy storage and supply technologies (e.g., ultracapacitors, lead-acid batteries).

The lithium ion electrochemical cells generally include non-aqueous liquids (e.g., aprotic organic solvents) as their electrolyte liquids, for example due to the incompatibility of lithium metal with water. In this regard, each electrochemical cell will generally include its own casing used to contain its specific components (e.g., electrodes, electrolyte fluids). Also, the lithium ion electrochemical cells and, in some instances, a housing of the battery modules containing these cells, may be sealed to limit exposure of the electrochemical cells and their internal components to moisture.

During operation (e.g., charging and discharging), the lithium ion electrochemical cells may become heated as a result of various electrochemical and thermodynamic processes occurring within the cells. This heat may cause the electrolyte liquids, among other things, to expand and in some situations volatilize, which in turn raises the internal pressure of the electrochemical cell and causes the individual casing of the electrochemical cells to expand. Further, as the lithium ion electrochemical cells experience an increase in internal pressure, they may begin to vent certain gases. For example, vented gases may include, but are not limited to, volatilized electrolyte.

For this reason, lithium ion electrochemical cells may be designed to withstand a certain amount of expansion, and may also include various interconnects or other features for venting gases into the battery module. Despite these approaches, in some instances, the degree of heating, or some other force placed upon lithium ion electrochemical cells, may be sufficient to cause one or more of the lithium ion electrochemical cells to vent a relatively large volume of gases into the housing of the battery module. To prevent rupture of the housing of the battery module, these gases may need to be vented as well.

Battery modules, therefore, may include a vent that enables the release of these gases from the battery module and into the vent tube of a vehicle or other environment, respectively. However, it is presently recognized that venting systems associated with such modules may be subject to further improvement, for example by making the venting systems associated with such battery modules able to better resist a variety of environmental conditions.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present embodiments are directed to, among other things, a lithium ion battery system having a liquid trap system configured to collect liquid from a vent pathway associated with a lithium ion battery module. The vent pathway is configured to flow battery cell effluent away from the lithium ion battery module and out of the lithium ion battery system. The liquid trap system has a liquid removal path configured to fluidly couple to the vent pathway, a liquid collection vessel fluidly coupled to the liquid removal path and configured to collect liquid removed from the vent pathway, and a liquid outlet path of the liquid collection vessel configured to allow liquid to exit the liquid collection vessel. The liquid collection vessel has a position relative to the vent pathway that allows liquid within the vent pathway to move toward the liquid collection vessel by the force of gravity.

Present embodiments are also directed to a retrofit system for a vent path of a lithium ion battery system. The retrofit system includes a vent pathway extension configured to couple to a battery module vent of a lithium ion battery module at a first end and to couple to a conduit defining a vent pathway of the lithium ion battery system at a second end opposite the first end, a liquid removal path coupled to the vent pathway extension and configured to flow liquid from the vent pathway extension, a liquid collection vessel configured to couple to the liquid removal path and to collect liquid removed from the vent pathway extension, and a liquid outlet path positioned at a low point of the liquid collection vessel such that collected liquid flows out of the liquid outlet path under the force of gravity.

The present embodiments are also directed to, among other things, a lithium ion battery module including a housing enclosing a battery cell region comprising a plurality of lithium ion battery cells, a compartment separate from the battery cell region and having a liquid trap system fluidly coupled with a vent of the battery cell region configured to vent battery cell effluent, and a battery module vent fluidly coupled to the liquid trap system and configured to flow battery cell effluent out of the housing. The liquid trap system is positioned fluidly between the vent of the battery cell region and the battery module vent, and includes a liquid removal path configured to remove liquid at a point between the vent of the battery cell region and the battery module vent.

### DRAWINGS

Various aspects of this disclosure may be better understood upon reading the following detailed description and upon reference to the drawings in which:

FIG. 1 is a perspective view of an xEV having a battery system configured in accordance with present embodiments to provide power for various components of the xEV, in accordance with an aspect of the present disclosure;

FIG. 2 is a cutaway view of an embodiment of the xEV having a start-stop system that utilizes the battery system of FIG. 1, the battery system having a lithium ion battery module, in accordance with an aspect of the present disclosure;

FIG. 3 is an illustration of an embodiment of the xEV of FIG. 2 having a liquid trap system positioned within the battery system and configured to remove water from a vent path of the battery system, in accordance with an aspect of the present disclosure;

FIG. 4 is an illustration depicting an embodiment of the liquid trap system of FIG. 3 having a liquid removal path, a liquid collection vessel, and a liquid outlet path for removing liquid from a vent path of the battery system, in accordance with an aspect of the present disclosure;

FIG. 5 is an illustration depicting an embodiment of the liquid trap system where the liquid collection vessel has tapered sides that converge at a liquid outlet, in accordance with an aspect of the present disclosure;

FIG. 6 is an illustration depicting an embodiment of the liquid trap system having two liquid outlets coupled by the liquid collection vessel, where the liquid collection vessel is a curved conduit, in accordance with an aspect of the present disclosure;

FIG. 7 is an illustration depicting an embodiment of the liquid trap system where the liquid collection vessel is a curved conduit having a continuously open liquid outlet, in accordance with an aspect of the present disclosure;

FIG. 8 is an illustration depicting an embodiment of a retrofit system having the liquid trap system, the retrofit system being configured to be coupled to existing vent features of a battery system, in accordance with an aspect of the present disclosure; and

FIG. 9 is an illustration depicting an embodiment of a lithium ion battery module having the liquid trap system positioned within a housing of the module and fluidly coupled between a vent of a battery cell region and a vent of the module, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As set forth above, the battery systems described herein may be used to provide power to a number of different types of xEVs as well as other energy storage applications (e.g., electrical grid power storage systems). Such battery systems may include one or more battery modules, each battery module having a number of battery cells (e.g., lithium ion electrochemical cells) arranged to provide particular voltages and/or currents useful to power, for example, one or more components of an xEV, or parts of a home or business. As also described above, the various venting processes that may occur in such battery modules may, in some situations, require relatively large volumes of gases to be expelled from the battery module.

It is now recognized that in certain applications, lithium ion battery systems having one or more lithium ion battery modules may be subject to ingress of certain elements, such as water, from the external environment. For example, in some situations, a boat having a lithium ion battery module may have a vent hose (e.g., a vent conduit) configured to facilitate venting of battery cell effluent out of the module and out of the boat. However, the vent hose may be positioned such that water may splash into the vent hose (e.g., as the boat travels along the water), which can be undesirable for a number of reasons. Similarly, if a motor vehicle is travelling along a wet road, water may splash into the vent hose, which may be undesirable. For instance, the water may be trapped in portions of the vent hose, thereby blocking the vent path formed by the vent hose and restricting the ability of the battery module to vent. This restriction can increase internal pressures in the battery module, and possible rupture of its housing or other undesirable effects.

The present disclosure addresses these and other issues by providing, among other things, a vent system that includes a liquid trap system tied into a vent conduit associated with a battery system. In accordance with present embodiments, the liquid trap system may direct liquids (e.g., water) within a vent hose to a liquid accumulation section that is separate from a main vent path of the vent conduit. Accordingly, effluent from battery cells in the battery system may travel through the main vent path while liquid in the conduit is directed to the liquid accumulation section. In certain embodiments, the liquid accumulation section may include one or more sensors configured to detect the presence of a liquid, one or more liquid release features to enable accumulated liquid to be directed out of the vent system, and other features.

While it is envisioned that the embodiments noted above and described in further detail below may be applied to any battery subject to venting as described herein, the present approaches are particularly applicable to lithium ion battery modules that are subject to the various environmental and operating conditions associated with, for example, driving a vehicle or other operating conditions where exposure to environmental liquids is possible.

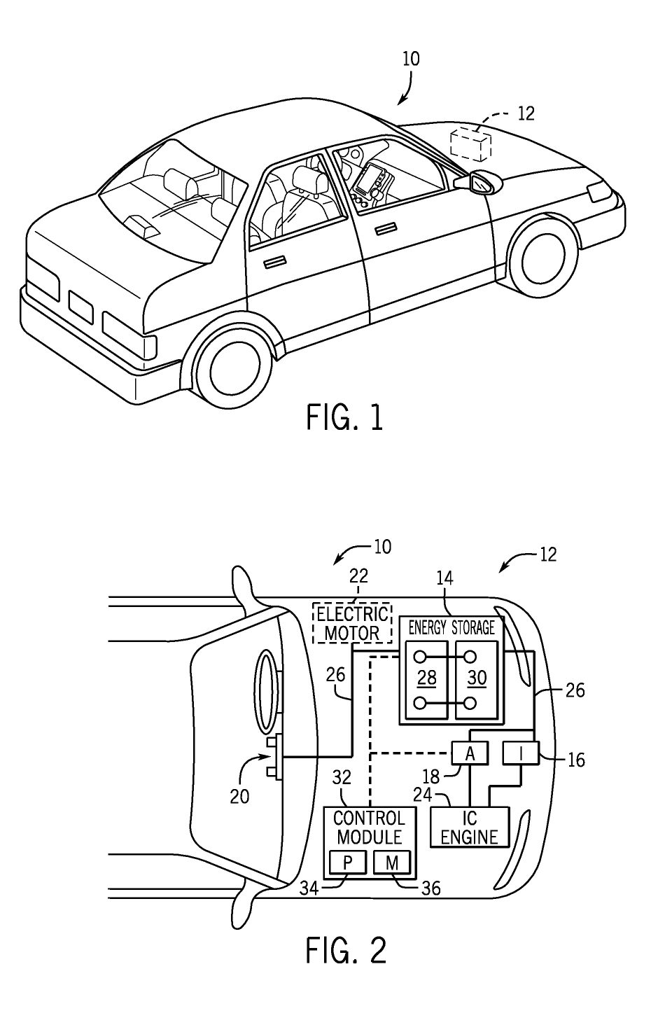

To help illustrate, FIG. 1 is a perspective view of an embodiment of a vehicle 10, which may utilize a regenerative braking system. Although the following discussion is presented in relation to vehicles with regenerative braking systems, the techniques described herein are adaptable to other vehicles that capture/store electrical energy with a battery, which may include electric-powered and gas-powered vehicles, as well as other non-automotive (e.g., stationary) applications. Accordingly, while the present embodiments are described in the context of a vehicle incorporating the vent system described herein, it should be recognized that the vent system is intended to be applicable to a number of different battery systems.

It is now recognized that it is desirable for a non-traditional battery system 12 (e.g., a lithium ion car battery) to be largely compatible with traditional vehicle designs. In this respect, present embodiments include various types of battery modules for xEVs and systems that include xEVs. Accordingly, the battery system 12 may be placed in a location in the vehicle 10 that would have housed a traditional battery system. For example, as illustrated, the vehicle 10 may include the battery system 12 positioned similarly to a lead-acid battery of a typical combustion-engine vehicle (e.g., under the hood of the vehicle 10). Furthermore, as will be described in more detail below, the battery system 12 may be positioned to facilitate managing temperature of the battery system 12. For example, in some embodiments, positioning a battery system 12 under the hood of the vehicle 10 may enable an air duct to channel airflow over the battery system 12 and cool the battery system 12.

A more detailed view of the battery system 12 is described in FIG. 2. As depicted, the battery system 12 includes an energy storage component 14 coupled to an ignition system 16, an alternator 18, a vehicle console 20, and optionally to an electric motor 22. Generally, the energy storage component 14 may capture/store electrical energy generated in the vehicle 10 and output electrical energy to power electrical devices in the vehicle 10.

In other words, the battery system 12 may supply power to components of the vehicle's electrical system, which may include radiator cooling fans, climate control systems, electric power steering systems, active suspension systems, auto park systems, electric oil pumps, electric super/turbochargers, electric water pumps, heated windscreen/defrosters, window lift motors, vanity lights, tire pressure monitoring systems, sunroof motor controls, power seats, alarm systems, infotainment systems, navigation features, lane departure warning systems, electric parking brakes, external lights, or any combination thereof. Illustratively, in the depicted embodiment, the energy storage component 14 supplies power to the vehicle console 20 and the ignition system 16, which may be used to start (e.g., crank) the internal combustion engine 24.

Additionally, the energy storage component 14 may capture electrical energy generated by the alternator 18 and/or the electric motor 22. In some embodiments, the alternator 18 may generate electrical energy while the internal combustion engine 24 is running. More specifically, the alternator 18 may convert the mechanical energy produced by the rotation of the internal combustion engine 24 into electrical energy. Additionally or alternatively, when the vehicle 10 includes an electric motor 22, the electric motor 22 may generate electrical energy by converting mechanical energy produced by the movement of the vehicle 10 (e.g., rotation of the wheels) into electrical energy. Thus, in some embodiments, the energy storage component 14 may capture electrical energy generated by the alternator 18 and/or the electric motor 22 during regenerative braking. As such, the alternator and/or the electric motor 22 are generally referred to herein as a regenerative braking system.

To facilitate capturing and supplying electric energy, the energy storage component 14 may be electrically coupled to the vehicle's electric system via a bus 26. For example, the bus 26 may enable the energy storage component 14 to receive electrical energy generated by the alternator 18 and/or the electric motor 22. Additionally, the bus may enable the energy storage component 14 to output electrical energy to the ignition system 16 and/or the vehicle console 20. Accordingly, when a 12 volt battery system 12 is used, the bus 26 may carry electrical power typically between 8-18 volts.

Additionally, as depicted, the energy storage component 14 may include multiple battery modules. For example, in the depicted embodiment, the energy storage component 14 includes a lithium ion (e.g., a first) battery module 28 and a lead-acid (e.g., a second) battery module 30, which each includes one or more battery cells. In other embodiments, the energy storage component 14 may include any number of battery modules. Additionally, although the lithium ion battery module 28 and lead-acid battery module 30 are depicted adjacent to one another, they may be positioned in different areas around the vehicle. For example, the lead-acid battery module 30 may be positioned in or about the interior of the vehicle 10 while the lithium ion battery module 28 may be positioned under the hood of the vehicle 10.

In some embodiments, the energy storage component 14 may include multiple battery modules to utilize multiple different battery chemistries. For example, when the lithium ion battery module 28 is used, performance of the battery system 12 may be improved since the lithium ion battery chemistry generally has a higher coulombic efficiency and/or a higher power charge acceptance rate (e.g., higher maximum charge current or charge voltage) than the lead-acid battery chemistry. As such, the capture, storage, and/or distribution efficiency of the battery system 12 may be improved.

To facilitate controlling the capturing and storing of electrical energy, the battery system 12 may additionally include a control module 32. More specifically, the control module 32 may control operations of components in the battery system 12, such as relays (e.g., switches) within energy storage component 14, the alternator 18, and/or the electric motor 22. For example, the control module 32 may regulate amount of electrical energy captured/supplied by each battery module 28 or 30 (e.g., to de-rate and re-rate the battery system 12), perform load balancing between the battery modules 28 and 30, determine a state of charge of each battery module 28 or 30, determine temperature of each battery module 28 or 30, control voltage output by the alternator 18 and/or the electric motor 22, and the like.

Accordingly, the control unit 32 may include one or more processors 34 and one or more memory units 36. More specifically, the one or more processor 34 may include one or more application specific integrated circuits (ASICs), one or more field programmable gate arrays (FPGAs), one or more general purpose processors, or any combination thereof. Additionally, the one or more memory 36 may include volatile memory, such as random access memory (RAM), and/or non-volatile memory, such as read-only memory (ROM), optical drives, hard disc drives, or solid-state drives. In some embodiments, the control unit 32 may include portions of a vehicle control unit (VCU) and/or a separate battery control module. Furthermore, as depicted, the lithium ion battery module 28 and the lead-acid battery module 30 are connected in parallel across their terminals. In other words, the lithium ion battery module 28 and the lead-acid module 30 may be coupled in parallel to the vehicle's electrical system via the bus 26.

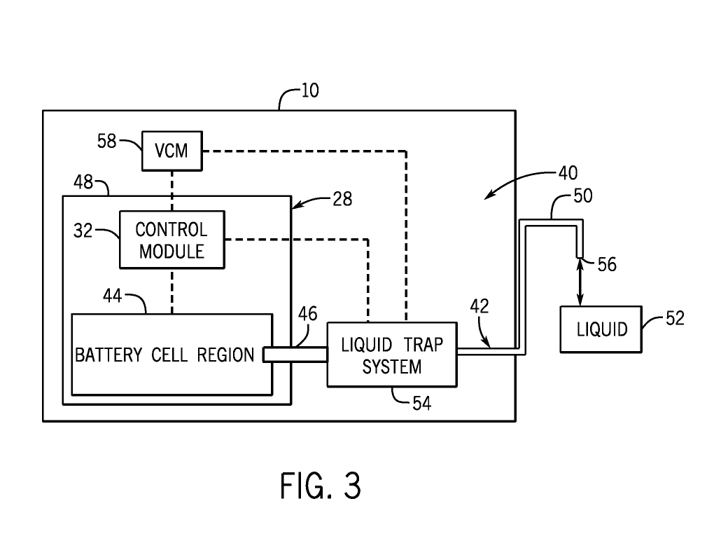

As set forth above, during certain operational conditions, the lithium ion battery module 28 may vent effluent from its battery cells to the external environment. As illustrated in FIG. 3, this may be accomplished using a venting system 40, which includes a vent pathway 42 configured to carry battery cell effluent out of a battery cell region 44 of the battery module 28 (or battery system having multiple such modules) and to an external environment. In the illustrated embodiment, for example, the vent pathway 42 includes a module vent 46 extending from the battery cell region 44 and out of a housing 48 of the module 28. Though illustrated as a single feature, the module vent 46 may include one or more valves, semi-permeable membranes, one or more pathways within the housing 48, and so forth, that are collectively configured to enable effluent from battery cells to be carried away from the battery cell region 44 (e.g., to exit the module 28).

The module vent 46, as illustrated, is fluidly coupled to a vent conduit 50 (e.g., a vent hose) configured to flow battery cell effluent from an interior of the xEV 10 to the external environment. As shown, in certain situations, the vent conduit 50 may be subject to environmental liquids 52, which may enter into the vent conduit 50. To mitigate some of the undesirable effects of the liquid ingress (e.g., to prevent blockage of cell effluent), in accordance with present embodiments the illustrated vent system 40 includes a liquid trap system 54 configured to trap all or a substantial portion of the liquid 52.

The illustrated liquid trap system 54 may be at least partially positioned in fluid communication with the module vent 46 and the vent conduit 50, and may be configured to collect the liquid 52 at a point along the vent pathway 42 between the module vent 46 and an outlet 56 of the vent conduit 50. As described in further detail below, the liquid tap system 54 may include various devices that enable drainage of the liquid 52 from the liquid trap system 54, sensing of the presence and/or amount of the liquid 52, and so forth. Certain of these devices may provide feedback to the control module 32 associated with the battery module 28 and/or a vehicle control module (VCM) 58 of the xEV 10, either or both of which may in turn control various functions of the xEV 10, the battery module 28, and/or the liquid trap system 54 to further mitigate effects that the liquid 52 may have on the battery system 12.

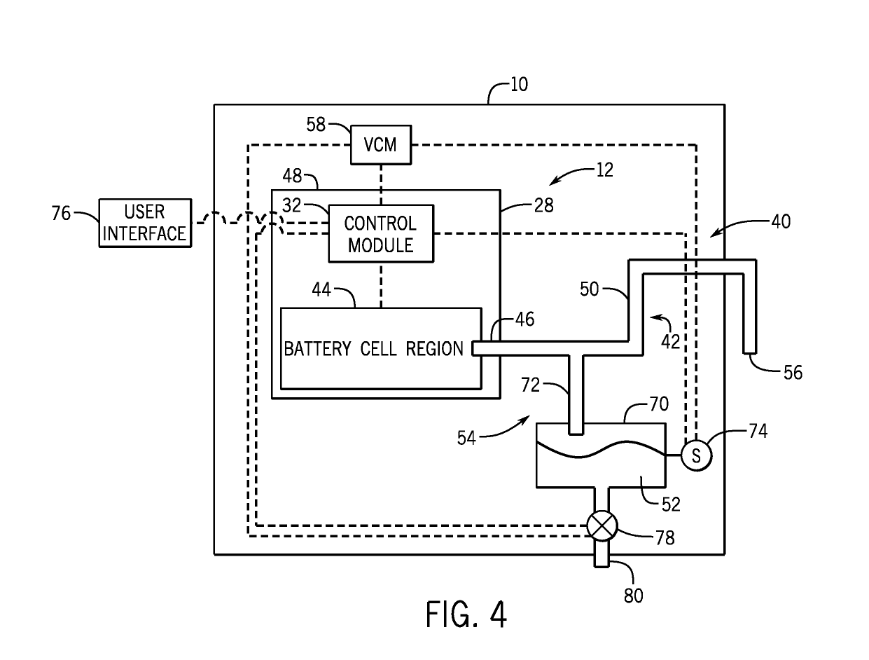

Such features may be appreciated with reference to FIG. 4, which illustrates an embodiment of the liquid trap system 40 having a liquid collection vessel 70 fluidly coupled to the vent pathway 42 via a liquid removal path 72. As shown, the liquid 52 may be removed from the vent pathway 42 via the liquid removal path 72, and may collect in the liquid collection vessel 70. As an example, the liquid removal path 72 may include one or more conduits that are fluidly coupled to the vent pathway 42 at a point between the outlet 56 of the vent pathway 42 and the module vent 46. The liquid removal path 72 may remove the liquid 52 from the vent pathway 42 using gravity, where the density of the liquid 52 causes it to flow through the liquid removal path 72 and into the liquid collection vessel 70. Accordingly, in one embodiment, the liquid collection vessel 70 may be positioned to allow settling of the liquid 52 without substantial backflow of the liquid 52 into the vent pathway 42. For example, the liquid collection vessel 70 may be positioned below the battery module 28 and the vent outlet 56. Additionally or alternatively, the liquid removal path 72 may be configured to remove the liquid 52 from the vent pathway 42 using another moving fluid, e.g., using the Venturi effect.

As set forth above, certain elements of the liquid trap system 40 may be communicatively coupled to the VCM 58 and/or the control module 32. As depicted in FIG. 4, for example, the liquid collection vessel 70 (or other liquid collection feature) may include one or more sensors 74 configured to provide feedback to the VCM 58 and/or the control module 32 indicative of the presence of the liquid 52. By way of non-limiting example, the one or more sensors 74 may include a water sensor, a liquid level sensor, a pressure sensor, a temperature sensor, or any other sensor that may be used to provide a direct or an indirect indication of the presence of the liquid 52 (e.g., water). As shown, the one or more sensors 74 may be positioned on or within the liquid collection vessel 70, but in certain embodiments the liquid trap system 40 may additionally or alternatively include similar sensors along the liquid removal path 72.

In response to determining that the one or more sensors 74 have detected the presence of the liquid 52 in the liquid collection vessel 70, the VCM 58 and/or the control module 32 may cause an indication to be provided (e.g., via a user interface) to a driver of the xEV 10 (or other user of a system having the battery system 12) that the battery system 12 may need service. As an example, the VCM 58 may cause the vehicle console 20 (see FIG. 2) or other vehicle feature to provide a warning or similar indication to the driver. Additionally or alternatively, the control module 32 may cause a user interface 76 (e.g., a display or one or more lights) to provide the indication.

The VCM 58 and/or the control module 32 may also perform automated procedures in response to determining that the one or more sensors 74 have detected the presence of the liquid 52 in the liquid collection vessel 70. For example, the VCM 58 and/or the control module 32 may be communicatively coupled to a valve 78 (e.g., a valve actuator) positioned along an outlet path 80 (e.g., a conduit) of the liquid collection vessel 70. The VCM 58 and/or the control module 32, in response to determining the presence of the liquid 52, may cause the valve 78 to actuate to allow the liquid 52 collected in the vessel 70 to drain through the outlet path 80.

Additionally or alternatively, the user interface 76 may provide a user the capability to control when the valve 78 is opened and closed. For example, the user interface 76 may include a touch screen interface, a keypad, or one or more buttons, knobs, or other control switches, that enable the user to initiate drainage of the liquid 52 from the liquid collection vessel 70 (e.g., using the valve 78). In certain embodiments, the user interface 76 may be a part of the vehicle console 20.

The liquid trap system 54 may take a number of different forms, and its configuration is not necessarily limited to the configuration illustrated in FIG. 4. Indeed, embodiments of the liquid trap system 54 may include any one or a combination of the features shown in FIG. 4 (e.g., the one or more sensors 74, the valve 78, the liquid collection vessel 70), or may not include any of these features and may simply include a feature configured to route the liquid 52 out of the vent path 42. Further, the positions, shapes, and interconnections of the elements of the liquid trap system 54 may vary. As one example, the liquid collection vessel 70 does not necessarily have to have a square or rectangular cross-sectional geometry as shown.

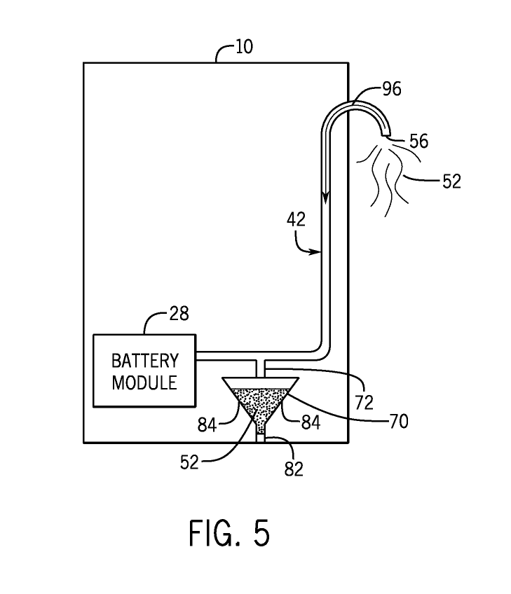

Referring now to FIG. 5, for example, the liquid collection vessel 70 may have a triangular or tapered cross-sectional shape. Such a shape of the liquid collection vessel 70 may be desirable so that the liquid 52 collected in the vessel 70 may flow toward a plug 82 to allow for removal of the collected liquid 52. The plug 82 may be manually removable, or may be automated in accordance with the embodiments described above relative to the valve 78 (see FIG. 4). For example, in response to determining that a predetermined amount of the liquid 52 is present in the liquid collection vessel 70, the VCM 58 and/or the control module 32 may provide a user-perceivable indication that the plug 82 should be removed to allow drainage of the liquid 52, or may automatically open the plug 82 (e.g., using a plug actuator) to drain the liquid 52 out of the vessel 70.

The plug 82 may be positioned at any point on the liquid collection vessel 70. However, in certain embodiments the plug 82 may be positioned at a lowest point of the vessel 70, for example at a point where angled sides 84 of the vessel 70 taper and converge, to allow removal of substantially all the collected liquid 52. Indeed, the vessel 70 may be shaped so as to have a point or region where the liquid 52 flows due to gravity. The point or region may have the plug 82 or the valve 78 (see FIG. 4) to enable removal of a desired amount (e.g., substantially all) the liquid 52 from the vessel 70.

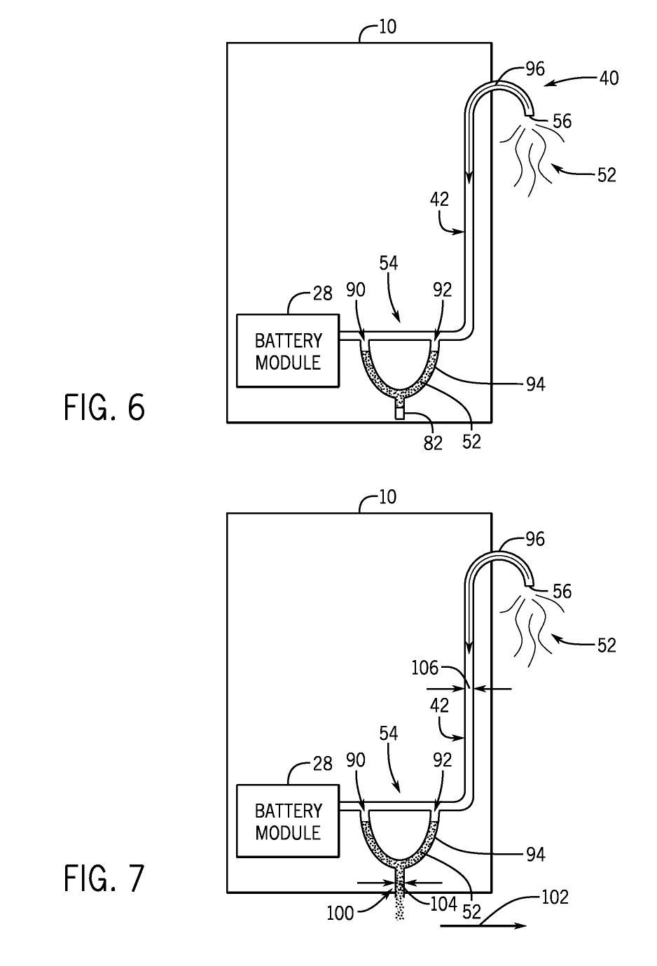

The embodiment shown in FIG. 5 may or may not include sensors, actuatable valve mechanisms, and so forth. Further, it should be noted that the liquid trap system 54 is not limited to embodiments where there is a single liquid removal path 72. Rather, the present disclosure encompasses embodiments where multiple liquid removal paths may be present, and may or may not be fluidly connected to one another. As set forth in FIGS. 6 and 7, for example, there may be at least two liquid removal paths that are fluidly connected by a single conduit.

In particular, FIG. 6 depicts an embodiment of the liquid trap system 54 including a first liquid outlet 90 and a second liquid outlet 92 (e.g., first and second liquid removal paths) disposed along the vent pathway 42. The first and second liquid outlets 90, 92 are positioned upstream of the vent outlet 56, and are fluidly connected by a curved (e.g., U-shaped) conduit 94, which is configured to collect a predetermined amount of the liquid 52 by being positioned below the vent pathway 42 and thereby allowing gravity settling of the liquid 52. In this way, the curved conduit 94 may be considered to constitute an embodiment of the liquid collection vessel 70. As shown, the liquid 52 may enter the vent outlet 52 in a counterflow direction 96 relative to a predetermined venting direction of the battery module 28, and, before reaching the battery module 28, may enter into the second liquid outlet 92 and/or the first liquid outlet 90 to be collected in the curved conduit 94.

The curved conduit 94 may also include a corresponding embodiment of the plug 82 (which may be the same as the plug 82 described above) to allow for removal of the collected liquid 52. Thus, the plug 82 may be manually removable, or may be automated in accordance with the embodiments described above relative to the valve 78 (see FIG. 4). The plug 82 may be positioned at any point along the curved conduit 94, but in certain embodiments may be positioned at a lowest point of the curved conduit 94 to allow removal of substantially all the collected liquid 52 (or at a point where gravity acts to direct the liquid 52).

In addition to or in lieu of including the plug 82 or the valve 78, as shown in FIG. 7, the curved conduit 94 may include a continuously open liquid outlet 100. The continuously open liquid outlet 100 may be positioned along the curved conduit 94 at its lowest point to allow maximum removal of the collected liquid 52, but may generally be positioned at any point that allows removal of the liquid 52 without operator or controller intervention. For example, the continuously open liquid outlet 100 may be positioned at a point along the curved conduit 94 such that once a predetermined amount of the liquid 52 is collected, any additional liquid 52 may automatically exit the continuously open liquid outlet 100. Further, in certain embodiments, the continuously open liquid outlet 100 may be positioned at an offset from the lowest point of the curved conduit 94, for example angled away from a forward direction of travel 102 of the xEV 10. In this way, as the xEV 10 begins to travel in the forward direction 102, additional gravitational forces may be placed on the liquid 52 that cause it to be pulled out of the continuously open liquid outlet 100.

It should be noted that the continuously open liquid outlet 100 may be sized so as to not create an area of low pressure within the vent pathway 42 that causes additional liquid 52 to be pulled into the vent pathway 42 through the vent outlet 56. For example, if the continuously open liquid outlet 100 is too large in diameter, liquid 52 exiting the continuously open liquid outlet 100 may flow out of the curved conduit 94 at a rate where fluid, such as air, rushes into the vent pathway 42 through the vent outlet 56 at a rate where the liquid 52 is also drawn in through the vent outlet 56. As a non-limiting example, the continuously open liquid outlet 100 may have a diameter 104 that is between 1% and 100% (e.g., between 10% and 80%, between 20% and 60%, or between 30% and 50%) of a diameter 106 of the vent pathway 42 (e.g., the vent outlet 56).

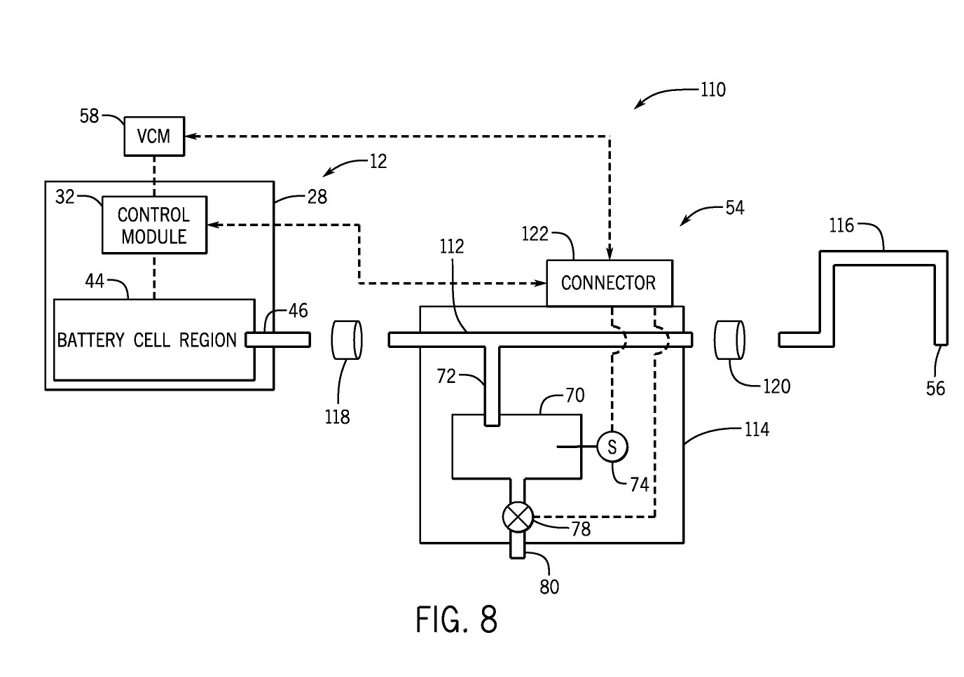

In accordance with certain aspects of the present disclosure, the liquid vent trap systems 54 described above may be retro fit into an existing battery system 12 and associated vent configuration. FIG. 8 illustrates an embodiment of a retrofit system 110 including the liquid trap system 54 with various interconnects to allow fitment to existing vehicle and battery connections. For example, the liquid collection vessel 70, liquid removal path 72, one or more sensors 74, one or more valves 78, liquid outlet path 80, and a vent pathway extension 112 are part of an integrated set 114 (e.g., all integrated into a single housing) that is configured to be placed fluidly between the battery module 28 (or battery pack having a plurality of modules 28) and a vent conduit 116 of the xEV 10 or other application.

The retrofit system 110 may also include, as illustrated, a first coupling 118 configured to secure the module vent 46 to the vent pathway extension 112 at a first side of the extension 112 and a second coupling 120 configured to secure the vent pathway extension 112 to the vent conduit 116 at a second side of the extension 112. As an example, the first and second couplings 118, 120 may individually include a hose adapter, a male (e.g., barbed) fitting, a washer, or similar feature that enables connection between conduits. However, in other embodiments, the vent pathway extension 112 may be a flexible hose that is capable of coupling directly to the module vent 46 (e.g., when the module vent 46 has a male fitting) without a separate adapting feature. Similarly, in embodiments where the vent conduit 116 is a flexible hose, the second coupling 120 may include a male fitting (e.g., a barbed fitting) capable of being inserted into the vent conduit 116. It is also within the scope of the present disclosure for the liquid trap system 54 to include a replacement for an existing version of the vent conduit 116 to reduce the number of interconnections between conduits.

The retrofit system 110 may also include a connector 122 (e.g., a communication port) that is configured to interface with the VCM 58 and/or the control module 32 to enable monitoring of the sensors 74 and control of the various valves 78, plugs 82, and so forth. For example, the connector 122 may be a pin connector having a standardized pin-out and geometry that allows ready connection to existing electronics in the xEV 10 and/or the battery module 28.

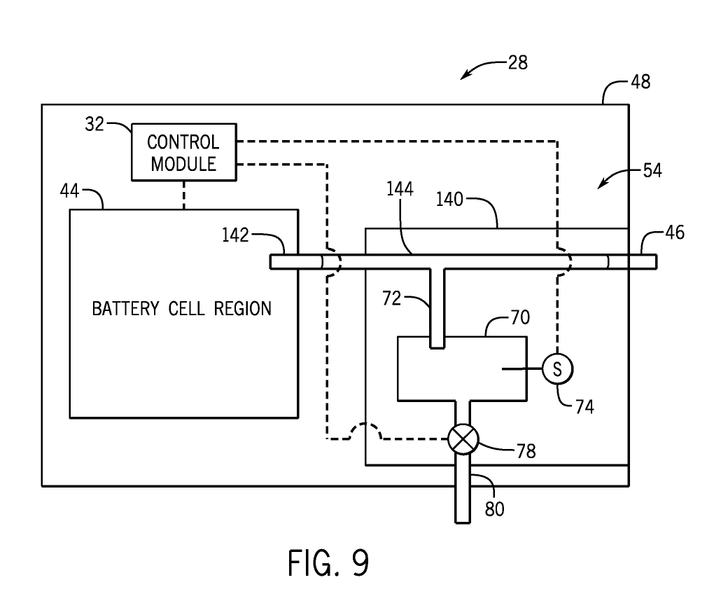

The liquid trap system 54 may also, as shown in the embodiment illustrated in FIG. 9, be integrated into the battery module 28 (or battery pack having multiple such modules 28). In such an embodiment, the battery cell region 44 may be separated from the liquid trap system 54 within the module housing 48 (e.g., by a permeability barrier) to avoid possible exposure of battery cells within the battery cell region 44 to trapped liquids (e.g., water).

As illustrated, the liquid trap system 54 may be located in a liquid trap compartment 140 separate from the battery cell region 44, and may have a fluid coupling only to a vent 142 of the battery cell region 44. Thus, the vent 142 of the battery cell region 44 may flow battery cell effluent (e.g., volatilized electrolyte) into the liquid trap system 54 (e.g., through a liquid trap conduit 144) and out of the battery module vent 46. The liquid trap system 54 is illustrated as including a liquid trap conduit 144 positioned fluidly between the vent 142 of the battery cell region 44 and the module vent 46. The liquid removal path 72 is located along the liquid trap conduit 144, and leads to the liquid collection vessel 70. The liquid collection vessel 70 is illustrated as including the liquid outlet 80 that exits a portion of the battery module housing 48 separate from the module vent 46.

One or more of the disclosed embodiments, alone or on combination, may provide one or more technical effects such as reducing the possibility of battery cell exposure to liquids. In addition, the liquid trap systems described herein may facilitate battery cell and battery module venting, thereby preventing possible overpressure situations. The liquid trap systems may also collect certain environmental liquids (e.g., water) from the vent path of a battery module or battery system, and may dispose of the liquids without detrimental effect to the module or system. The technical effects and technical problems in the specification are exemplary and are not limiting. It should be noted that the embodiments described in the specification may have other technical effects and can solve other technical problems.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A lithium ion battery system comprising:
a liquid trap system configured to collect liquid from a vent pathway associated with a lithium ion battery module, the vent pathway being configured to flow battery cell effluent away from the lithium ion battery module and out of the lithium ion battery system;
wherein the liquid trap system comprises a liquid removal path configured to fluidly couple to the vent pathway, a liquid collection vessel fluidly coupled to the liquid removal path and configured to collect liquid removed from the vent pathway, and a liquid outlet path of the liquid collection vessel configured to allow liquid to exit the liquid collection vessel;
wherein the liquid collection vessel has a position relative to the vent pathway that facilitates flow of liquid within the vent pathway toward the liquid collection vessel by the force of gravity.

2. The lithium ion battery system of claim 1, wherein the liquid removal path comprises a liquid removal conduit fluidly coupled to the vent pathway at a point between a vent of the lithium ion battery module and a vent outlet of the vent pathway.

3. The lithium ion battery system of claim 1, wherein the liquid removal path comprises a first liquid outlet and a second liquid outlet disposed along the vent pathway between a vent of the lithium ion battery module and a vent outlet of the vent pathway, wherein the first liquid outlet and the second liquid outlet are fluidly coupled to one another by the liquid collection vessel.

4. The lithium ion battery system of claim 3, wherein the liquid collection vessel comprises a curved conduit having a continuously open liquid outlet as the liquid outlet path, and the continuously open liquid outlet is sized to allow continuous output of liquid within the liquid collection vessel while avoiding creating sufficiently low pressure within the vent pathway to cause liquid to be pulled into the vent pathway.

5. The lithium ion battery system of claim 3, wherein the liquid collection vessel comprises a curved conduit having a plug closing the liquid collection vessel to the liquid outlet path, and the plug is manually removable to allow a user to drain the liquid collection vessel.

6. The lithium ion battery system of claim 3, wherein the liquid collection vessel comprises a curved conduit having a plug closing the liquid collection vessel to the liquid outlet path, and the plug is automatically actuatable by a control module associated with the lithium ion battery module to allow the control module to automatically drain the liquid collection vessel.

7. The lithium ion battery system of claim 1, wherein the liquid trap system comprises a sensor configured to detect the presence of liquid within the liquid collection vessel.

8. The lithium ion battery system of claim 7, comprising a user interface and a control module of the lithium ion battery module, wherein the user interface and the sensor are communicatively coupled to the control module, and the control module is configured to cause the user interface to provide a user-perceivable indication in response to determining that a predetermined amount of liquid is present within the liquid collection vessel.

9. The lithium ion battery system of claim 7, comprising a control module of the lithium ion battery module, wherein the liquid trap system comprises an automatically actuatable valve positioned at the liquid outlet path of the liquid collection vessel, wherein the automatically actuatable valve and the sensor are communicatively coupled to the control module, and the control module is configured to actuate the valve to enable liquid to flow out of the liquid collection vessel in response to determining that a predetermined amount of liquid is present within the liquid collection vessel.

10. The lithium ion battery system of claim 1, comprising the lithium ion battery module having a housing enclosing a battery cell region comprising a plurality of lithium ion battery cells, and wherein the liquid trap system is located within the housing and within a compartment separate from the battery cell region.

11. The lithium ion battery system of claim 10, wherein the battery module comprises a vent of the battery cell region coupled to a liquid trap conduit of the liquid trap system, wherein the liquid removal path is positioned along the liquid trap conduit, and wherein the liquid trap conduit is fluidly coupled to a battery module vent of the battery module configured to carry battery cell effluent out of the housing of the battery module.

12. The lithium ion battery system of claim 1, wherein the liquid collection vessel comprises a first side and a second side that are angled toward one another and converge at a point, and wherein the liquid outlet path is located at the point.

13. A retrofit system for a vent path of a lithium ion battery system, comprising:
a vent pathway extension configured to couple to a battery module vent of a lithium ion battery module at a first end and to couple to a conduit defining a vent pathway of the lithium ion battery system at a second end opposite the first end;
a liquid removal path coupled to the vent pathway extension and configured to flow liquid from the vent pathway extension;
a liquid collection vessel configured to couple to the liquid removal path and to collect liquid removed from the vent pathway extension; and
a liquid outlet path positioned at a low point of the liquid collection vessel such that collected liquid flows out of the liquid outlet path under the force of gravity.

14. The retrofit system of claim 13, wherein the vent pathway extension comprises a flexible conduit configured to receive a corresponding male connector of the battery module vent of the lithium ion battery module.

15. The retrofit system of claim 14, comprising a coupling configured to connect the second side of the vent pathway extension to the conduit defining the vent pathway.

16. The retrofit system of claim 13, comprising a sensor configured to detect the presence of liquid within the liquid collection vessel.

17. The retrofit system of claim 16, comprising an automatically actuatable valve disposed along the liquid outlet path and configured to adjust flow of the liquid out of the liquid collection vessel.

18. The retrofit system of claim 17, comprising an electrical connector configured to be communicatively coupled to a control module of the lithium ion battery module, or to a vehicle control module (VCM) of an xEV, or both, to enable communication between the control module or the VCM, or both, and the sensor and the automatically actuatable valve.

19. The retrofit system of claim 13, wherein the vent pathway extension, the liquid removal path, the liquid collection vessel, and the liquid outlet path are all integrated with one another within a single housing.

20. A lithium ion battery module comprising:
a housing enclosing a battery cell region comprising a plurality of lithium ion battery cells;
a compartment separate from the battery cell region and having a liquid trap system fluidly coupled with a vent of the battery cell region configured to vent battery cell effluent;
a battery module vent fluidly coupled to the liquid trap system and configured to flow battery cell effluent out of the housing; and
wherein the liquid trap system is positioned fluidly between the vent of the battery cell region and the battery module vent, and comprises a liquid removal path configured to remove liquid at a point between the vent of the battery cell region and the battery module vent.

21. The lithium ion battery module of claim 20, wherein the liquid trap system comprises a liquid trap conduit extending between the vent of the battery cell region and the battery module vent, wherein the liquid removal path is positioned along the liquid trap conduit.

22. The lithium ion battery module of claim 21, wherein the liquid trap system comprises a liquid collection vessel fluidly coupled to the liquid removal path and a liquid outlet path positioned on the liquid collection vessel, wherein the liquid outlet path is configured to allow liquid flow out of the liquid collection vessel.

23. The lithium ion battery module of claim 22, comprising a control module of the lithium ion battery module, wherein the liquid trap system comprises an automatically actuatable valve positioned at the liquid outlet path of the liquid collection vessel and a sensor configured to detect the presence of liquid within the liquid collection vessel, wherein the automatically actuatable valve and the sensor are communicatively coupled to the control module, and the control module is configured to actuate the valve to enable liquid to flow out of the liquid collection vessel in response to determining that a predetermined amount of liquid is present within the liquid collection vessel.
